(19) United States
(12) Patent Application Publication
(10) Pub. No.: US 2006/0070119 A1
(43) Pub. Date: Mar. 30, 2006

(54) Internet voting

(76) Inventor: Mark E. Ogram, Tucson, AZ (US)

Correspondence Address: Mark E. Ogram, ste 203, 7454 E. Broadway, Tucson, AZ, 85710, US

(21) Appl. No.: 10/935,920

(22) Filed: Sep. 7, 2004

(51) Int. Cl. H04L 9/32

(52) U.S. Cl. 726/4

(57) ABSTRACT

An Internet voting system which preserves the integrity of a data base containing records of cast votes. A vote collection computer operating on the Internet accepts a voter identification from a remote computer. If the voter identification is confirmed through a check of a data base, a query (i.e. the ballot) is sent to the voter and a response (i.e. a vote) to said query is accepted from the voter. A record of the response is then stored within a group of storage computers. This group of storage computers is chosen as a subset of a set of storage computers. By changing the subset of storage computers as votes are received, the ability of a hacker to gain access to the entire record and cause errors to occur is minimized or destroyed.

### BACKGROUND OF THE INVENTION

This invention relates generally to distributed computer systems such as the Internet and more particularly to the collection of data such as votes through the distributed computer system.

The present discussion relates to the collection of votes, but, the ivnention is not so limited and includes any data collection.

The Internet, and other existing distributed networks of computers, have changed the world dramatically. Barriers to access of knowledge and facts have crumbled; communication between individuals and companies have now become “instant”; reliance on traditional communication channels (i.e. mail systems) have been minimized; and, access to otherwise “hidden” goods and services has been created.

With the Internet, the world has become much smaller and more aware; but, with this easy access has come a danger from “hackers” who constantly seek out mischief and even intentional damage to the records.

The presence of hackers is one of the main reasons the Internet has not been used for the collection of votes. While the Internet would be a natural source of expanding voter turn out with its ease of use, there is a significant worry that hackers will be able to improperly influence the outcome of an election.

These worries boil down to two different concerns: (1) obtaining votes from only authorized individuals; and (2) preventing hackers from accessing and altering data bases which already have thousands (or even millions) of cast vote results.

Maintaining that only authorized voters are able to cast votes is a problem both in the real world and for any cyber-space voting. This problem is handled through a variety of traditional methods such as voting cards and identification of the individual.

The problem of making sure only authorized voting takes place though pales when the problem of voter data base manipulation is considered. When a hacker is able to gain access to the data base, whole elections are easily manipulated; and, there hasn't been any practical solution to prevent hackers from gaining access to these data-bases.

It is clear there is a need for an efficient and secure collection of data such as votes.

### SUMMARY OF THE INVENTION

The invention creates an Internet voting (or data collection) system which preserves the integrity of a data base containing records of cast votes. The present description relates to the collection of votes as a collection of data which is to be tabulated. While the following description relates to voting, the invention is not intended to be so limited but is equally applicable to other types of data collection such as: collection of health records from remote sites; census data; worldwide weather conditions; and many other applications obvious to those of ordinary skill in the art.

Further, the present discussion refers to the Internet; the invention though relates to a variety of distributed networks of computers well known to those of ordinary skill in the art. A distributed network allows a multitude of computers to gain access to others within the network and as such acts as a communication medium between the computers.

While the present invention uses the terms, “means for” function, the preferred embodiment implements this capability using a general purpose computer which has been programmed using a variety of languages to perform the function described. The programming of the general purpose computer is done using a variety of languages well known to those of ordinary skill in the art such as: Basic, Assembly, Colbol, and others.

In alternative embodiments, the “means for” function is accomplished using either special purpose computers (which are configured to accomplish a portion of the task) or even “hard wired” computers which are permanently configured to accomplish the function described. Those of ordinary skill the art readily recognize how these functions are implemented in either case.

The vote collection computer serves as the hub through which the other related computers operate. In the preferred embodiment, the vote collection computer uses the Internet to accept a voter identification from a remote computer.

A variety of techniques are available which will assist in the establishment of this voter identification. One such technique is the use of a swipe reader which is located at the voter's computer and allows the voter to “swipe” a magnetic stripe through the reader for positive identification of the voter. Since the “voter card” having the magnetic swipe is physically controlled by the voter, voter fraud is minimized.

Still other techniques are available in this context including: a unique password/ID which the voter enters at their terminal; a program within the voter's computer which provides a secure identification of the computer; a fingerprint reader located at the voter's computer; and many others obvious to those of ordinary skill in the art.

The voter identification is checked against a data-base of “authorized voters” or a voter registration log. This data-base is either kept at the voter collection computer or at a remote site which the voter collection computer accesses. This access is done ideally through a dedicated line (to prevent hacking of the data base) although alternative embodiments also use the Internet, other distributed networks, and even telephone systems.

If the voter identification is confirmed through a check of a data base, a query is sent to the voter. This query, in the voting example, is a “ballot” which presents the voting options available for the voter.

The query/ballot allows the voter to choose the options available that the voter desires. In the preferred embodiment, the query/ballot allows the voter to gain additional information concerning the issues. As example, should the voter not be familiar with a certain proposition, then by “clicking” on a “more information” button, the pros and cons concerning the proposition will be presented, allowing the voter to make a more informed decision.

Once the voter has completed the query/ballot, the response is checked to make sure it is in proper form (i.e. the voter has not voted for two people for the same office) and the response is sent to the vote collection computer (ideally in an encrypted form). This response is then placed in storage.

Within this invention, the response is stored within a group of storage computers. The particular group of storage computers is chosen as a subset of a larger set of storage computers. As example, assume there are fifty different storage computers which are going to be used, one in each state, then for a particular response (a cast vote) the response would be stored in three of the computers.

While the invention requires only two computers be in the subset where the response is stored, the preferred embodiment uses at least three computers. Three computers permit any variance within the record to be resolved (i.e. the vote within Computer A does not agree with Computers B and C, then the vote as recorded in Computers B and C is deemed “correct”).

By changing the subset of storage computers as votes are received, the ability of a hacker to gain access to the entire record is minimized or destroyed. A hacker may be able to gain access to one or even a few of the storage computers, but, this doesn't affect any significant number of the cast votes since the hacker would have to gain access to a majority of the subset's storage computers to have any affect on the vote itself.

The invention, together with various embodiments thereof, will be more fully explained by the accompanying drawings and the following description thereof.

### DRAWINGS IN BRIEF

FIG. 1 is a block diagram of the relationship of the various components of the preferred embodiment.

FIGS. 2A and 2B are flow-charts of the operation of the preferred embodiment for the operation of vote collection computer.

FIGS. 3A and 3B are flow-chart components of alternative methods for selecting the subset of storage computers.

FIG. 4 is a flow-chart of the preferred embodiment for operation of the tabulating computer

FIG. 5 graphically illustrates the memory structure within each of the storage computers.

FIGS. 6A and 6B illustrate alternative memory arrangements used for the establishment of the storage computers subsets.

FIG. 7 illustrates an embodiment of the memory used for voter registration.

### DRAWINGS IN DETAIL

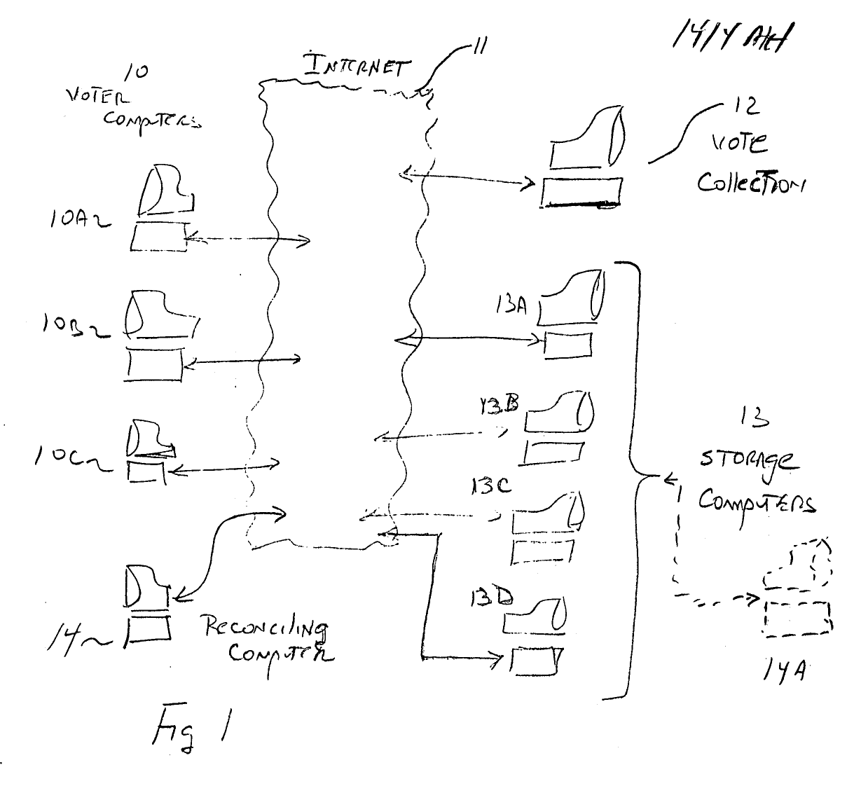

FIG. 1 is a block diagram of the relationship of the various components of the preferred embodiment. Within this discussion, the terms “voter computers”, “vote collection computers”, “storage computers”, and “reconciling computer” are labels only and are not intended to narrow the function of these computers.

As illustrated, Internet 11 forms the communication channel between the voter computers 10 and the vote collection computer 12. Further, Internet 11 allows communication between the vote collection computer 12 and the storage computers 13.

A voter uses his/her computer, such as voter computer 10A, to access the vote collection computer 12 via the Internet 11. In this manner, voter computer 10A (as directed by the user/voter) provides vote collection computer 12 with the voter's identification. The vote collection computer 12 communicates to voter computer 10A a query such as a ballot to be completed. When the voter has completed the ballot to their satisfaction, the voter directs his/her computer 10A to communicate the response to the vote collection computer 12.

Once the response has been received, vote collection computer 12 identifies a subset or group from the storage computers 13 and sends the response, together with a reference identifier, to the subset of storage computers 13. As example, suppose the subset chosen are storage computers 13A and 13B, then only these two storage computers receive the response and identifier.

When a second voter, using voter computer 10B, communicates a response to the vote collection computer 12, this second response (from the second voter computer 10B) is sent to a second subset of the storage computers 13. While the first subset and the second subset may be identical, the two subsets may also be different, thereby creating an interleaved or mixed grouping of responses and reference identifiers.

A similar operation is also done for voter computer 10C. While this discussion has described the use of one voter with one computer, the invention is not so limited. In some situations, a single voter computer is used by many different individuals. This permits remote areas to establish a computer link permitting a remote polling location to be established. One such example where this remote polling location is ideal is within the military allowing soldiers who are deployed in foreign countries to easily vote and not have to worry about “absentee” voting with all of its attendant problems.

This mixing of the storage computers prevents a hacker from gaining access to all of the records to affect the election. Typically a hacker might be able to “hack” into one or two of the computers, but, with the record being duplicated over a subset of computers (ideally having at least three computers), the possibility of any significant damage being done is minimized.

Once all of the votes have been received and stored, reconciling computer 14 accesses the storage computers 13 and obtains all of the data. While this is done in the preferred embodiment through Internet 11, in an alternative embodiment reconciling computer 14A is “off-line” and uses either dedicated links with storage computers 13 or the telephone system.

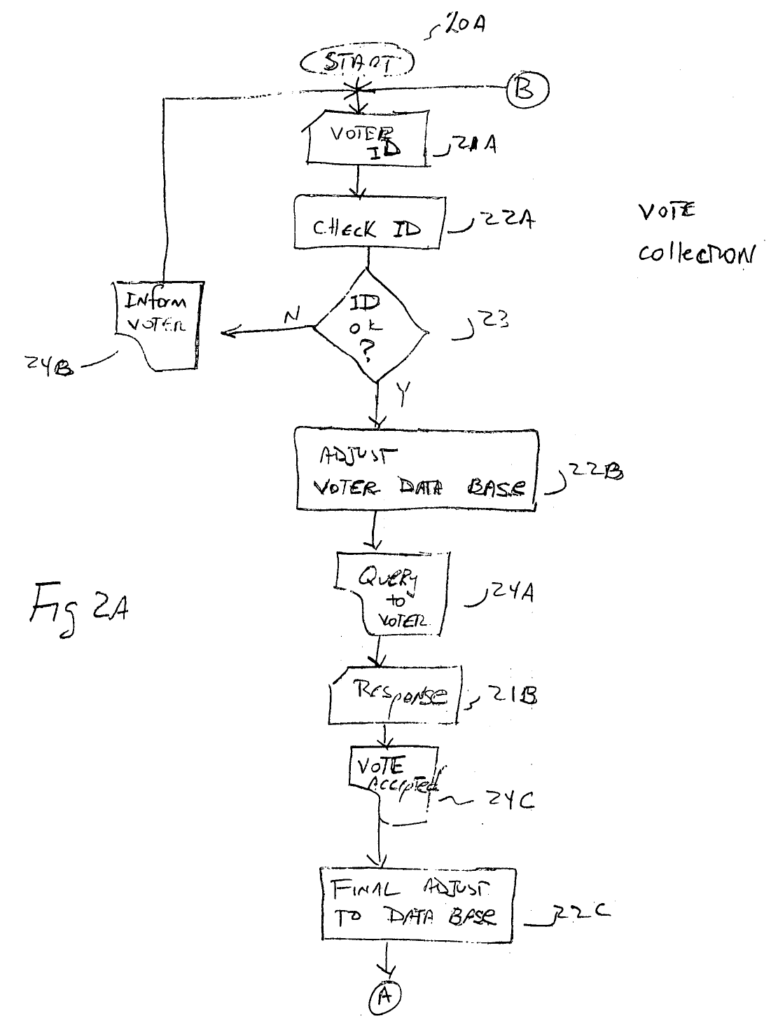

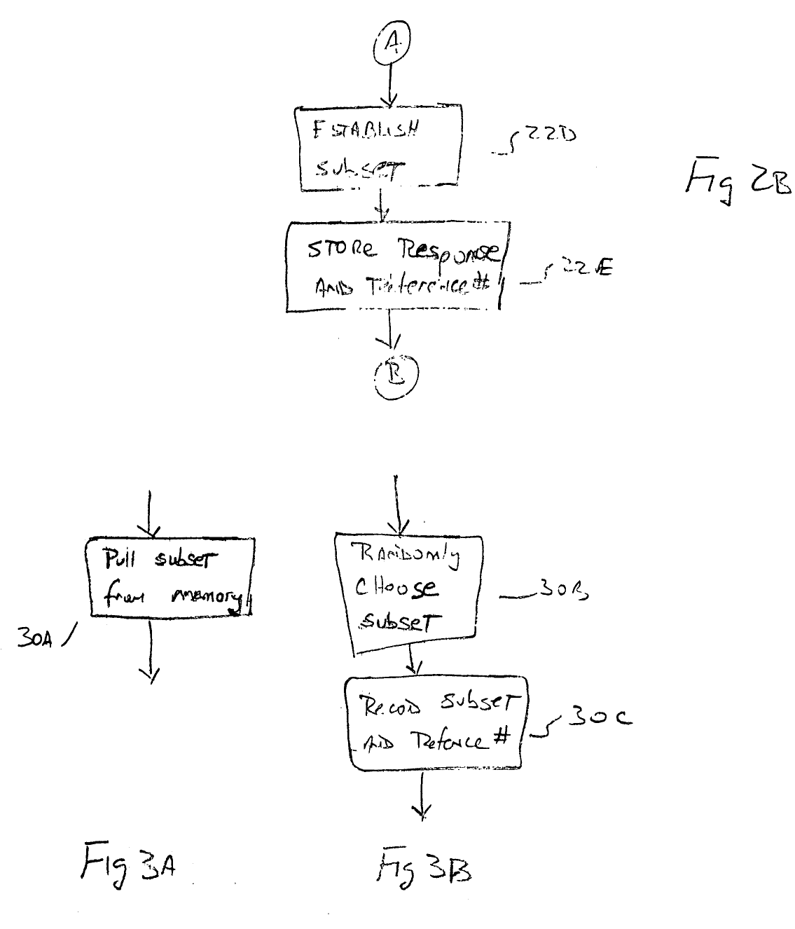

FIGS. 2A and 2B are flow-charts of the operation of the preferred embodiment for the operation of vote collection computer. These two flow-charts are to be combined for this discussion.

Once the program starts 20A, the voter ID is obtained 21A from the remote voter computer via the Internet. This voter ID is compared to a data-base of registered voters 22A to ascertain the voter's status. This status may be unregistered; dead; active; or already voted, as well as others well known to those of ordinary skill in the art.

The voter identification is checked 23 and if it is not valid, then the program informs the voter 24B of this condition and the program returns to handle a different voter.

If the voter ID is acceptable 23, then the voter registration data base is adjusted 22B. In this embodiment, the adjustment of the data base is done two times. This first adjustment sets a flag to show that the voter has attempted to vote; only later is the data base adjusted to show that a vote has been received and logged.

At this point, the query or ballot is communicated to the voter 24A and the voter's response is received 21B. A message 24C to the voter that the vote has been accepted is sent and the data base of voter registrations is adjusted to indicate the voter has completed voting 22C. This two step adjustment to the voter registration data base permits the voter to either voluntarily or involuntarily break the connection with the vote collection computer and still be able to re-connect and place their vote.

At this point, the vote collection computer establishes a subset of storage computers 22D and the response, together with a reference number is stored in each of the subset of storage computers 22E.

The program then returns to handle the input from another voter 21A.

FIGS. 3A and 3B are flow-chart components of alternative methods for selecting the subset of storage computers.

Referring to FIG. 3A, this method of establishing a subset of storage computers is used within the operation 22D of FIG. 2B.

In this technique, the memory from the vote collection computer is used to pull a pre-established subset 30A therefrom. In this embodiment, a pre-determined listing of subsets is created prior to the election. This allows the vote collection computer to easily establish which subset is to be used as the subsets are pulled sequentially from the memory.

FIG. 3B illustrates another embodiment of the invention in which a random number generator is used to establish the subset of storage computers. While “random number generators” are well known in the field, due to their properties, the sequence of numbers which are generated are determined by the original “key” or “seed” number. Thereafter though, there isn't any discernable pattern.

With the random number generator technique, the reconciling computer need only have the same random number generator program and the same “key” or “seed” to establish the same sequence of subsets that the vote collection computer generates.

As shown in FIG. 3B, the subset is randomly chosen 30B, and in this embodiment, is recorded in memory with a reference number 30C. This combination of reference number and vote permits the reconciling computer to easily cross check on the accuracy of the various data bases within the storage computers.

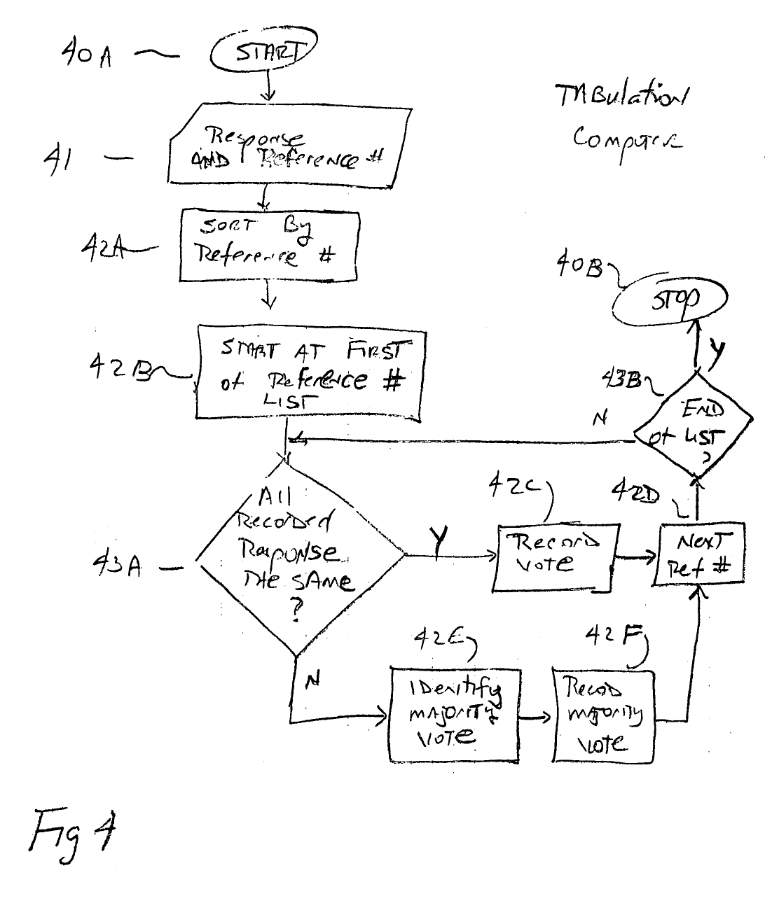

FIG. 4 is a flow-chart of the preferred embodiment for operation of the tabulating computer.

Once the program starts 40A, the responses and reference numbers 41 are obtained from the storage computers. These responses are then sorted by reference number 42A, thereby providing a grouping of the response individual responses.

Starting with the first reference number 42B, a check is made to see if all of the recorded responses are identical 43A. If the responses all correspond to each other, then the vote is recorded 42C and the next reference number is identified 42D.

A check is made to see if it is the end of the list 43B, and if it is then the program stops 40B; otherwise the next set records for the response is checked 43A.

Should all of the records of the response not be identical 43A (indicating either a tampering or a faulty operation of the storage computer), then the vote having the majority within the record is identified 42E and that “majority” vote is recorded 42F. The next reference number is obtained 42D and the program continues.

In this manner, the reconciling computer is able to go through the entire record and establish which votes should be recorded.

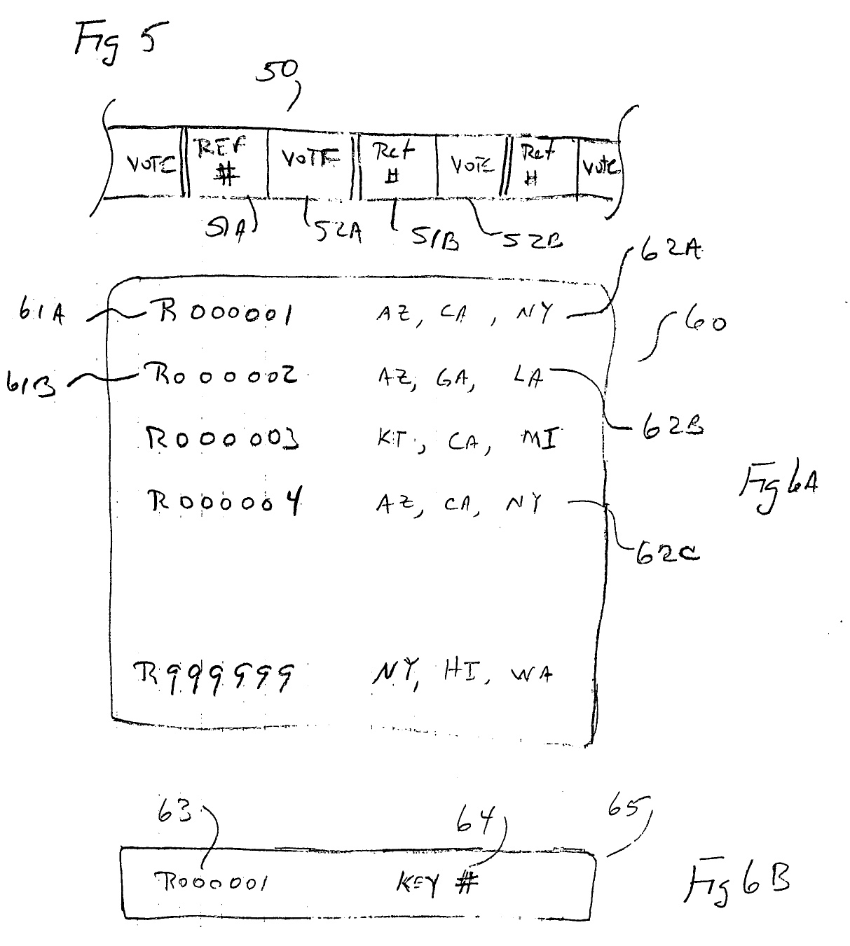

FIG. 5 graphically illustrates the memory structure within each of the storage computers.

Memory 50 is a sequence of reference numbers (51A, 51B) with their associated vote/response (52A, 52B). The reference numbers are usually not sequentially organized and serve to match a particular response from one storage computer with the responses stored in the other storage computers within the subset.

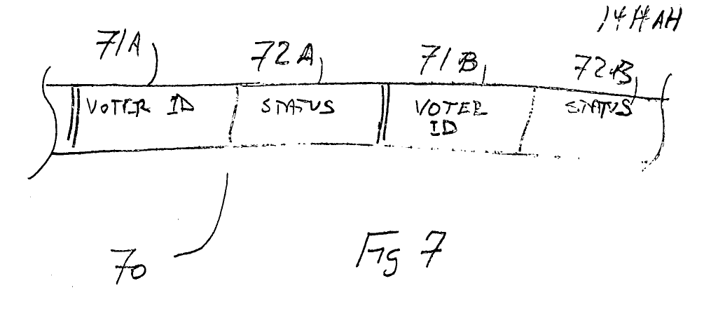

FIGS. 6A and 6B illustrate alternative memory arrangements used for the establishment of the storage computers subsets.

Prior to the election, a sequence of subsets (each consisting of three states where storage computers are located) is created and stored within memory 60 of the vote collection computer. This memory contains a reference number (61A, 61B) with associated states (62A, 62B, and 62C). Note, most subsets are unique (i.e. 62A compared with 62B), but, some of the subsets of storage computers are identical (i.e. 62A and 62C).

During operation, the vote collection computer uses these subsets to direct the vote/data to the proper storage computers.

As example, the second vote received, the contents of the vote will be sent to AZ, GA, and LA (62B) together with the associate reference number R000002. When the reconciling computer operates on the data within these computers (AZ, GA, and LA), the reference number will be used to bundle the three results together so that a comparison can be made.

In the embodiment in which a random number generator is used to establish the subsets, both the reconciling computer and the vote collection computer have within their associated memory contents 65. This memory contains the first reference number 63 together with the key/seed number 64 which will be used to initiate the random number generator.

Since the program used for generating the random number generator is identical within both the reconciling computer and the vote collection computer, and since the key number is identical, the sequence produced in both instance will be identical; hence, the subsets established by the random number generator will also be identical.

Establishment of the subsets is easily accomplished by having the random number generator produce random numbers between 0 and 99. By taking the next highest even number, each of the fifty states is randomly chosen (where each of the states has been assigned a whole number between 2 and 100). In this approach, a particular state can be listed multiple times within the subset of storage computers without violating the technique of choosing a subset.

FIG. 7 illustrates an embodiment of the memory used for voter registration.

Voter registration data base 70 is a sequence of voter identifications (71A, 71B) with associated status indicators (72A, 72B). The status indicators indicate the voter's ability to vote (i.e. dead, not registered, moved, eligible, etc.) and is checked and updated by the voter collection computer when it is determining if the voter can cast a vote.

It is clear the present invention provides for an efficient and secure collection of data such as votes.

What is claimed is:

1. A data collection system comprising:
a) a network linking remote computers to each other; and,
b) a first computer, a second computer, and a third computer communicating through said network,
1) said first computer collecting user generated data, and
2) said second computer having means for,
A) presenting a query to said first computer,
B) receiving a response to said query from the first computer, and,
C) storing said response in said third computer.

2. The data collection system according to claim 1,
a) wherein said third computer is in a set of at least three computers; and,
b) wherein said second computer further includes means for,
1) identifying a first subset of computers being a subset of said set of at least three computers, said first subset having at least two computers as elements thereof such that said third computer is in said first subset, and,
2) storing said response in a memory of each computer within said first subset of computers.

3. The data collection system according to claim 2, wherein said second computer includes means for establishing a unique identification for the user of said first computer.

4. The data collection system according to claim 3, wherein said second computer includes means for,
a) comparing the unique identification of said user to a data base of authorized users and generating a comparison reference therefrom; and,
b) based upon said comparison reference, selectively activating said means for presenting a query to said first computer.

5. The data collection system according to claim 4, wherein said second computer further includes means for updating said data base of authorized users based upon said comparison reference.

6. The data collection system according to claim 2, wherein said second computer further includes means for, via said network:
a) presenting said query to a second user;
b) receiving a response from said second user;
c) identifying a second subset of computers being a subset of said set of at least three computers, said second subset having at least two computers as elements thereof, and,
d) storing the response from said second user in the memory of each computer within said second subset of computers.

7. The data collection system according claim 6, wherein said second computer includes means for:
a) storing a user identifier with each response in the memory of each computer within said first subset of computers; and,
b) storing a user identifier with each response in the memory of each computer within said second subset of computers.

8. The data collection system according to claim 6, wherein said second subset is not identical to said first subset.

9. The data collection system according to claim 8, further including a fourth computer having means for:
a) withdrawing data from the memory of each computer within said set of computers; and,
b) reconciling data from each computer within the first subset and the second subset of computers.

10. The data collection system according to claim 6, wherein said second computer includes:
a) a memory containing a sequence of subsets; and,
b) wherein said first subset and said second subset are sequential within said memory.

11. The data collection system according to claim 8, wherein said second computer includes means for randomly establishing said first subset of computers and said second subset of computers.

12. The data collection system according to claim 11, wherein said means for randomly establishing said first subset of computers and said second subset of computers includes means for randomly generating numbers beginning at a pre-selected origin.

13. An Internet voting system comprising:
a) a network linking remote computers to each other; and,
b) a first voter computer, a vote collection computer, and a first storage computer communicating through said network,
1) said first voter computer collecting user generated data, and
2) said vote collection computer having means for,
A) accepting a voter identification from said first voter computer,
B) presenting a query to said first voter computer,
C) receiving a response to said query from the first voter computer, and,
D) storing said response in said first storage computer.

14. The Internet voting system according to claim 13,
a) wherein said first storage computer is in a set of at least three storage computers; and
b) wherein said vote collection computer further includes means for,
1) identifying a first subset of storage computers being a subset of said set of at least three storage computers, said first subset having at least two storage computers as elements thereof such that said first storage computer is in said first subset, and,
2) storing said response in a memory of each computer within said first subset of storage computers.

15. The Internet voting system according to claim 14, wherein said vote collection computer includes means for,
a) comparing the voter identification to a data base of authorized users and generating a comparison reference therefrom;
b) based upon said comparison reference, selectively activating said means for presenting a query to said first voter computer; and,
c) updating said data base of authorized users based upon said comparison reference.

16. The Internet voting system according to claim 14, wherein said vote collection computer further includes means for:
a) obtaining a second voter identification from a second voter computer;
b) presenting said query to the second voter computer;
c) receiving a second response from said second voter computer;
d) identifying a second subset of storage computers being a subset of said set of at least three storage computers, said second subset having at least two storage computers as elements thereof, and,
e) storing the second response in the memory of each computer within said second subset of storage computers.

17. The Internet voting system according to claim 16, wherein said second subset is not identical to said first subset.

18. The Internet voting system according to claim 28, further including a tabulating computer having means for:
a) withdrawing data from the memory of each storage computer within said set of computers; and,
b) reconciling data from each storage computer.

19. A voting system comprising:
a) a network linking remote computers to each other; and,
b) a first voter computer collecting user generated data;
c) a set of at least three storage computers; and,
d) a vote collection computer having means for, via said network,
A) accepting a voter identification from said first voter computer,
B) presenting a query to said first voter computer,
C) receiving a first response to said query from the first voter computer,
D) identifying a first subset of storage computers being a subset of said set of at least three storage computers, said first subset having at least two storage computers as elements thereof, and,
E) storing said response in a memory of each storage computer within said first subset of storage computers.

20. The voting system according to claim 19, wherein said vote collection computer includes means for,
a) comparing the voter identification to a data base of authorized users and generating a comparison reference therefrom; and,
b) based upon said comparison reference, selectively activating said means for presenting a query to said first voter computer.

21. The voting system according to claim 20, wherein said vote collection computer further includes means for updating said data base of authorized users based upon said comparison reference.

22. The voting system according to claim 20, wherein said vote collection computer further includes means for:
a) obtaining a second voter identification from a second voter computer;
b) presenting said query to the second voter computer;
c) receiving a second response to said query from said second voter computer;
d) identifying a second subset of storage computers being a subset of said set of at least three storage computers, said second subset having at least two storage computers as elements thereof; and,
e) storing the second response in the memory of each computer within said second subset of computers.

23. The voting system according to claim 22, wherein said second subset is not identical to said first subset.

24. The voting system according to claim 23, further including a tabulating computer having means for:
a) withdrawing data from the memory of each storage computer within said set of storage computers;
b) reconciling data from each storage computer within the first subset of storage computers; and,
c) reconciling data from each storage computer within the second subset of storage computers.
